(19) United States
(12) Patent Application Publication
(10) Pub. No.: US 2008/0169070 A1
(43) Pub. Date: Jul. 17, 2008

(54) System for attaching a fabric storm cover over an opening in a building

(75) Inventors: Willis J. Mullet, Gulf Breeze, FL (US); Darius H. Grimes, Cantonment, FL (US); Stephen J. Borona, Pensacola, FL (US)

Correspondence Address: Andrew B. Morton;RENNER, KENNER, GREIVE, BOBAK,, TAYLOR & WEBBER, First National Tower, Fourth Floor, Akron, OH, 44308-1456, US

(73) Assignee: Wayne-Dalton Corp.

(21) Appl. No.: 11/653,454

(22) Filed: Jan. 16, 2007

(51) Int. Cl. E06B 3/30; E06B 9/00

(52) U.S. Cl. 160/369; 160/371

(57) ABSTRACT

A system for protecting an opening, such as a window (11) in a structure (12) includes a fabric cover (13) having spaced openings (14) around the periphery thereof. In one embodiment, a frame (21) includes a track (27) and a stem (24) which is received in a slot (20) formed on the periphery of the window (11). The track (27) carries connector assemblies (15) which are received through the openings (14) in the cover (13) to attach the cover (13) to the frame (21). In another embodiment, the track is formed in a component (50) of a frame (40) and a web (42) attached the component (50) to another frame component (41) which is attached by fasteners (60) adjacent to the window (11).

### TECHNICAL FIELD

This invention relates to a system of attaching a fabric storm cover over an opening in a building such as a window or the like. More particularly, this invention relates to a system for positioning a plurality of mounting bolts around the periphery of the opening so that a fabric storm cover can be attached thereto.

### BACKGROUND ART

In geographic areas which are prone to having high wind events, such as hurricanes and the like, the need exists for the protection of openings, such as windows and doors, in buildings. Otherwise, if the high winds or wind-borne debris breaches the integrity of the structure by destroying a window or door, severe damage to the structure can be expected.

One type of known protection device which can be utilized is a simple sheet of plywood which can be attached to the structure so as to cover the openings thereof. However, this “boarding up” procedure is not only time consuming, when time is usually of the essence, but also can disfigure the exterior of the structure upon frequent installation and removal. In addition, plywood has a limited life, particularly after becoming wet. Finally, storing and maintaining an inventory of plywood sheets can be problematic. As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also they do not provide the necessary wind or water resistant seal.

More recently, fabric-based systems have been developed which are much less costly than the metallic shutters or other devices, and which can provide a seal for the openings in the structure. In a more sophisticated form, the fabric is oftentimes rolled up and stored in a housing above the opening and is payed out from the roll as the fabric curtain is pulled down between two side rails. When the fabric reaches the bottom sill of the structure, it is typically held in place by devices which engage the side rails or it can be locked into the bottom sill. Such systems can be motorized for automatic operation.

More simply, the fabric systems may include a sheet of fabric which is strong enough to withstand high winds and the forces of wind-borne debris without rupturing. These fabric sheets may be sealed on all four edges, thus providing a seal for the structure even if the glass of a window, for example, has been broken, or a door blown open.

In its most simple form, a fabric sheet of material is provided with a plurality of grommet-reinforced openings spaced along two or four sides thereof. A like plurality and similarly spaced fasteners extend outwardly from the structure around the opening in the structure to be protected, and the fasteners are received through the openings in the fabric so that the sheet can be attached to the fasteners and to the structure to protect the opening. However, a simple system of positioning the fasteners around the opening at the precise desired location has heretofore not been developed and is the subject of the present invention.

### DISCLOSURE OF THE INVENTION

It is thus one object of the present invention to provide a system of protecting an opening in a structure by locating and mounting a plurality of fasteners so that the fasteners may be received through apertures formed in a fabric storm cover to attach the cover to the structure.

It is another object of the present invention to provide a system, as above, which is applicable to specially designed window frames or conventional window frames.

It is a further object of the present invention to provide a system, as above, wherein no modification to the window frame is necessary.

It is an additional object of the present invention to provide a system, as above, in which the fabric sheet of material is spaced from the conventional window frame a sufficient distance so that, if the sheet is deflected, the window will not be broken.

It is yet another object of the present invention to provide a system, as above, which when used with a specifically designed window frame does not require fasteners other than those used to carry the fabric storm cover.

It is still another object of the present invention to provide a system, as above, wherein a frame is mounted adjacent to the conventional window opening and that frame carries the fasteners for the storm cover.

It is another object of the present invention to provide a system, as above, which can be adapted to protect multiple side-by-side window openings.

These and other objects of the present invention, as well as the advantages thereof over existing prior art forms, which will become apparent from the description to follow, are accomplished by the improvements hereinafter described and claimed.

In general, a system for protecting an opening in a building includes a fabric cover having spaced openings along edges thereof. A frame is positioned around the periphery of the opening and a track is formed in the frame. A plurality of connector assemblies are positioned in the track at the location of the spaced openings in the cover, and the connector assemblies attach the cover to the frame and over the opening.

In accordance with another aspect of the invention, a frame is adapted to be received in a slot formed around the periphery of an opening in a building to be protected by a fabric cover. The frame includes a track and a plurality of connector assemblies positioned in the track and adapted to carry the cover. A stem extends from the track and is adapted to be received in the slot.

Also in accordance with the invention, a frame is adapted to be mounted adjacent to an opening in a building to be protected by a fabric cover. The frame has a first component carrying a track and a second component adapted to be attached adjacent to the opening. A web connects the first and second components.

Preferred exemplary systems for protecting the opening in a building according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a window opening in a structure in need of a storm protection mounting system of the present invention

FIG. 2 is an exploded perspective view showing the manner in which a protective storm fabric curtain can be attached to cover the window of FIG. 1.

FIG. 3 is a perspective view of the window of FIG. 1 having the protective storm fabric curtain attached thereto.

FIG. 4 is an exploded view of one embodiment of a frame structure for positioning and mounting a plurality of fasteners around a specially designed window frame.

FIG. 5 is an enlarged exploded view of the encircled portion of FIG. 4.

FIG. 5A is similar to FIG. 5 but showing the components assembled.

FIGS. 6A, 6B and 6C are exploded sectional views taken substantially along line 6-6 of FIG. 5A and showing three alternative track assembly profile configurations.

FIG. 7 is a perspective view of a conventional window opening having another embodiment of a frame structure attached thereto.

FIG. 8 is a sectional view taken substantially along line 8-8 of FIG. 7

FIG. 9 is a sectional view similar to FIG. 8 but showing the frame structure differently oriented.

FIG. 10 is a perspective view of a window opening that is generally twice the size of the window of FIG. 7 and showing the manner in which the present invention is applicable to such a window.

### PREFERRED EMBODIMENTS FOR CARRYING OUT THE INVENTION

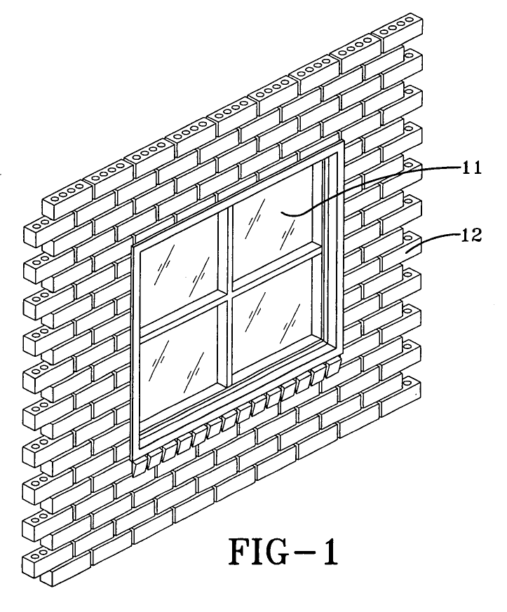

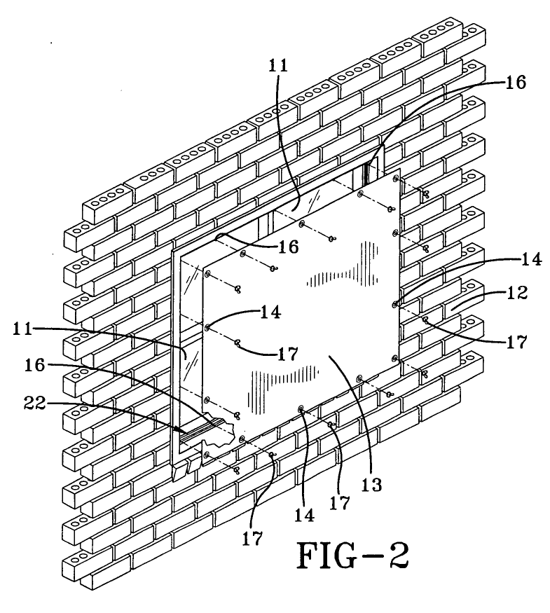

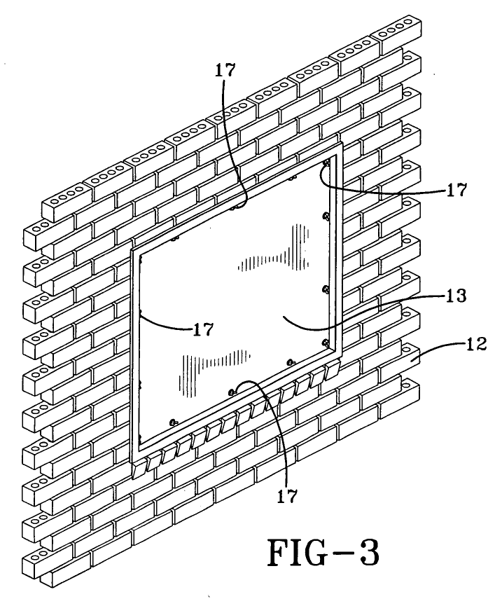

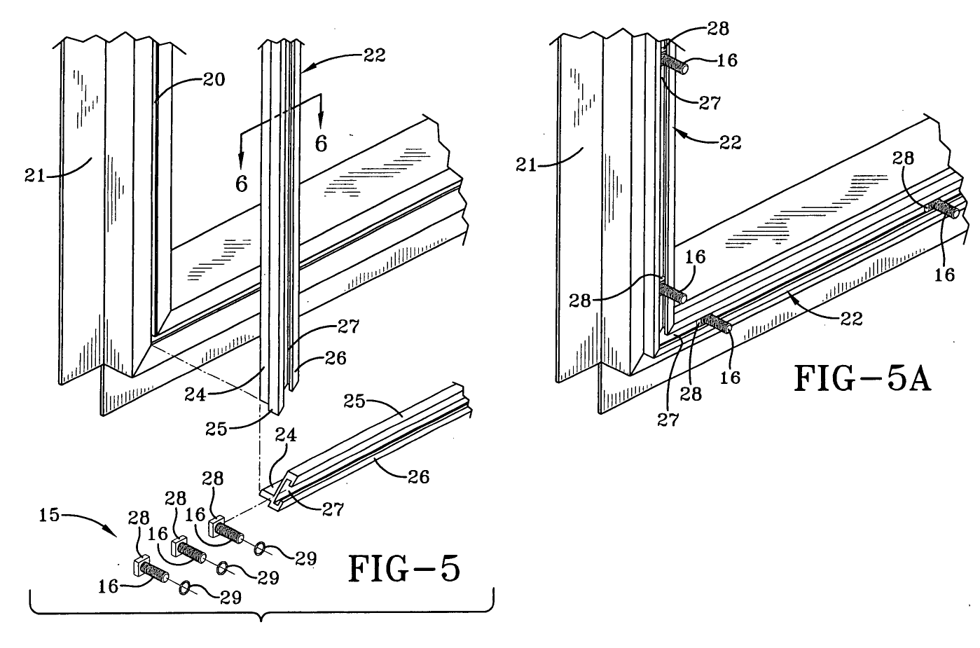

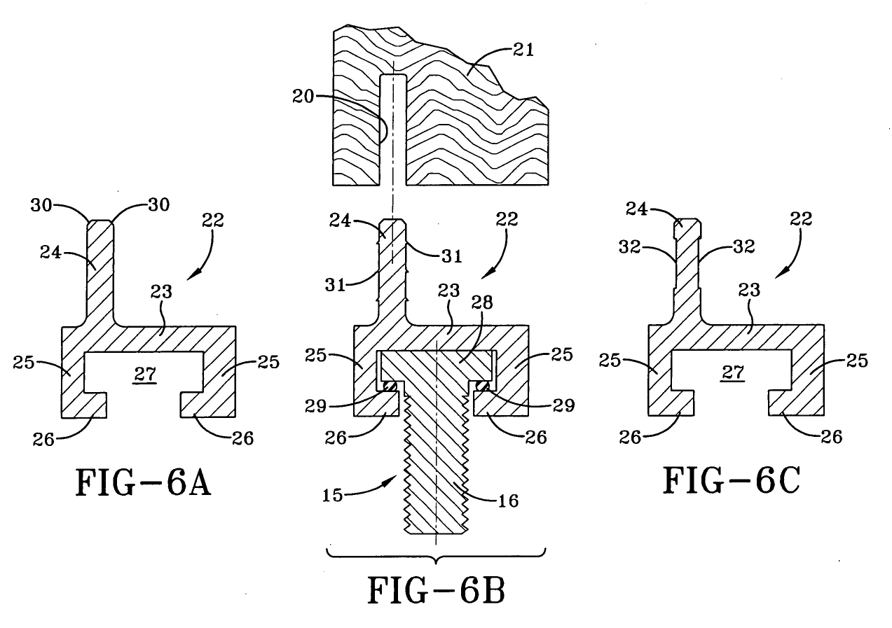

FIG. 1 depicts a typical window 11 positioned in a structure 12 shown to be made of brick. However, the specific type of finish for structure 12 is not relevant to the present invention. FIGS. 2 and 3 show a fabric cover 13 being installed over window 11 to protect the same against the forces of wind or airborne debris as might be encountered during a hurricane or other severe storm event. Cover 13 can be made in accordance with pending U.S. patent application Ser. No. 11/190,114 to which reference is made for whatever details may be necessary to understand the present invention. As such, cover 13 is provided with a plurality of grommet-reinforced openings 14 spaced along the periphery thereof. While openings 14 are shown as being positioned in the entire periphery of cover 13, it is to be understood that such could be provided only on the side edges, or only on the top and bottom edges of cover 13. A like plurality of connector assemblies, generally indicated by the numeral 15, and shown, for example, in FIGS. 5 and 6, are spaced along the periphery of window 11 with the spacing of assemblies 15 matching that of grommet openings 14. Each connector assembly 15 includes a threaded shaft 16 extending outwardly from the periphery of window 11. Shafts 16 are adapted to be received through openings 14 in cover 13, and wing nuts 17 or the like may be tightened on shafts 16 to engage cover 13 to mount it over window 11 as shown in FIG. 3.

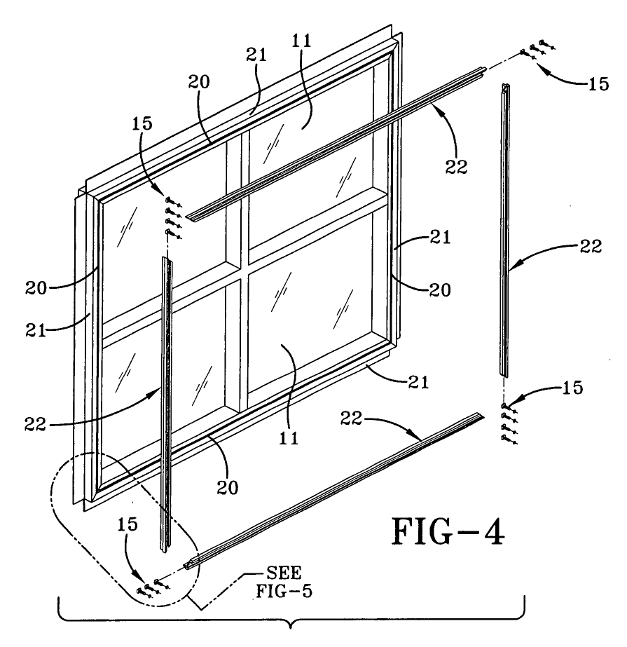

The present invention relates, in general, to the manner in which connectors 15 are positioned and carried around window 11, and the applicability of the present invention to several types of windows 11 is envisioned. For example, one type of window 11 and the details thereof is shown in FIGS. 4-6. In this type of window 11, a peripheral slot 20 is provided in the frame 21 which extends around the entire window 11. When adapted for this type of window, the present invention includes a plurality of track assemblies generally indicated by the numeral 22. A track assembly 22 is thus provided for the top, bottom and each side of window 11. Each track assembly 22 is generally C-shaped and includes a base 23 which carries a stem 24. Opposed side walls 25 extend from the ends of base 23 is a direction opposite to stem 24. The other end of each side wall 25 is provided with a lip 26. Lips 26 extend toward each other and form, with base 23 and side walls 25, a generally T-shaped track 27.

Each connector assembly 15 includes a generally square head 28 at one end of each threaded shaft 16. The heads 28 of a plurality of connector assemblies are slidably received in the track 27 of each track assembly 22. As should be evident, the connector assemblies 15 can then be spaced around window 11 with the same spacing as openings 14 in cover 13. An o-ring 29 may be provided around shaft 16 to assist in holding each connector assembly 15 at the desired location. Thus, as shown in FIG. 6B, o-rings 29 are positioned between head 28 and lips 26 to provide enough friction to maintain connector assemblies 15 at the desired location.

The connector assemblies 15 may be positioned in track assemblies 22, as just described, either before or after the track assemblies 22 are attached to the window frame 21. To attach track assemblies 22 to frame 21, in most instances a good friction fit between stem 24 and slot 20 will suffice. As shown in FIG. 6A, stem 24 may be provided with a starting bevel 30 at the end thereof, and stem 24 may be manually, or with the assistance of a mallet, inserted into slot 20. For slots of wider tolerances, it may be necessary to provide one or more lock barbs 31 or the surface of stem 24, as shown in FIG. 6B. Alternatively, as shown in FIG. 6C, stem 24 may be provided with an undercut groove 32 to receive an adhesive or the like to fix track assemblies 22 to frame 21. It should be appreciated that with track assemblies 22 in place, as shown in FIG. 2, fabric cover 13 can be positioned over window 11 in the manner previously described.

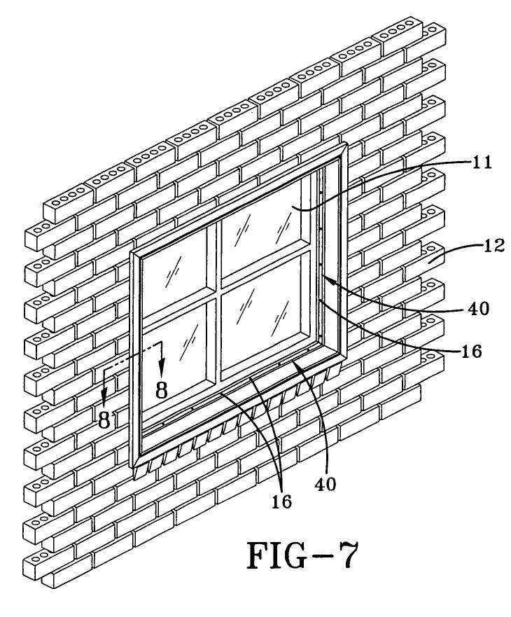

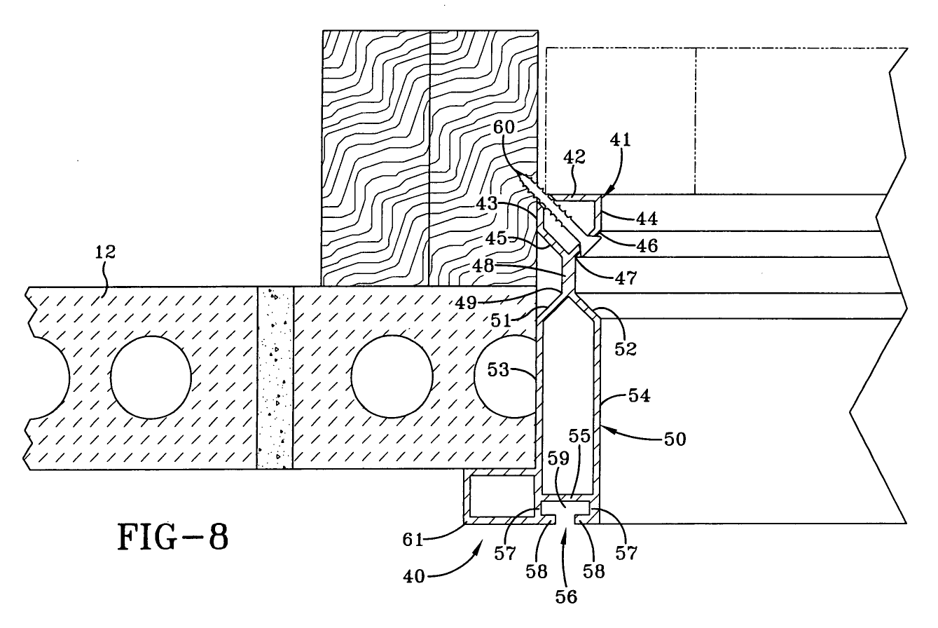

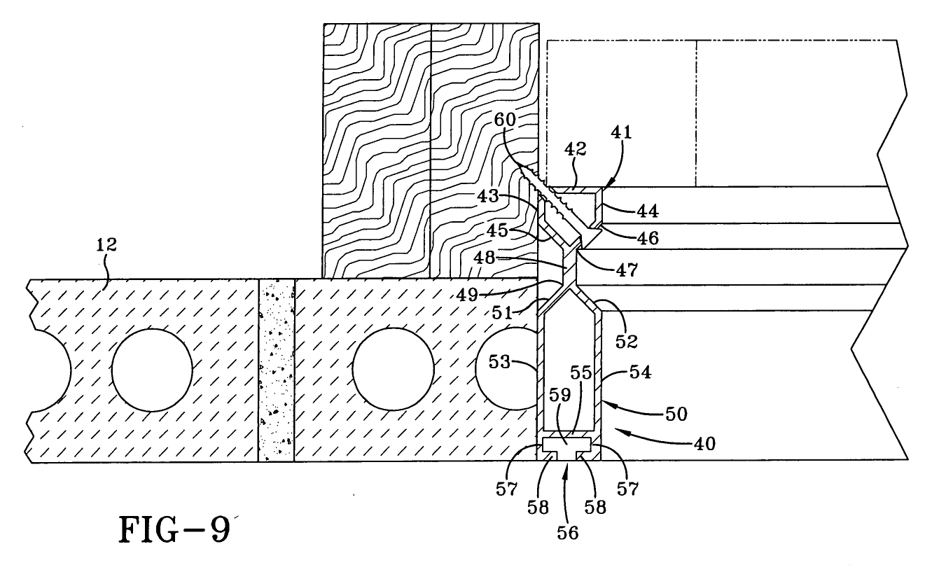

In accordance with another aspect of the present invention, if the window 11 is not of the type having a frame 21 with a slot 20 therein, a specially configured frame, generally indicated by the numeral 40 and shown in FIGS. 7-9, may be provided. A frame 40 is provided across the top and bottom of window 11 and along the sides of window 11. These four frames 40 can be of the same configuration, and two alternative configurations are shown in FIGS. 8 and 9, now to be discussed.

Each frame 40 includes an inner pentagon-shaped frame component, generally indicated by the numeral 41, having a base wall 42 adapted to rest against the frame of window 11 and opposed side walls 43 and 44 extending outwardly from the end of wall 42. End walls 45 and 46 extend angularly inwardly from the end of walls 43 and 44, respectively, and intersect at corner 47. A web 48 extends from corner 47 to the corner 49 of a larger, pentagon-shaped frame component generally indicated by the numeral 50. Component 50 generally mirrors component 41, that is, end walls 51 and 52 extend angularly outwardly from web 28, with opposed side walls 53 and 54 being formed at the end of walls 51 and 52, respectively. Side walls 53 and 54 terminate at a base number 55. Base number 55 is part of a track assembly, generally indicated by the numeral 56, which is preferably identical to track assembly 22 previously described. That is, track assembly 56 is generally C-shaped and includes opposed side walls 57 extending outwardly from base number 55. The other end of each side wall 57 is provided with a lip 58. Lips extend toward each other to form a track 59 which, like track 52, can receive connector assemblies 15 in the manner previously described.

Frames 40 are versatile in that the same frame configuration may be used for the top, bottom, left side or right side of a window 11. Moreover, fasteners 60 may be used for three distinct mounting options are provided by frame 40. First, as shown in FIGS. 8 and 9, fasteners 60 may be received through end wall 46 and through the corner between walls 42 and 43 and into the window frame structure. In this configuration, wall 53 of frame component 50 is received snugly against the brick structure 12. Moreover, in the embodiment shown in FIG. 8, frame 40 is shown as being provided with a flange block 61 which forms a trim over the brick structure 12. Or, as shown in FIG. 9, frame 41 can be flushly mounted with brick structure 12.

As a second alternative to mounting frame 40, if it is to be mounted on the other side of window 11 from that shown in FIGS. 8 and 9, the fasteners 60 may extend through end wall 45 and through the corner formed between walls 42 and 44 and into the window frame structure. In this instance, wall 54 of frame component 50 is received snugly against the brick structure 12.

In any position around window 11, frame 40 may also be attached by inserting fasteners 60 directly through web 48. In all of the mounting options, it should be noted that fasteners 60 are below the appearance level of frame 41 because of the angles walls 45, 46, 51 and 52 and their interconnection by web 48.

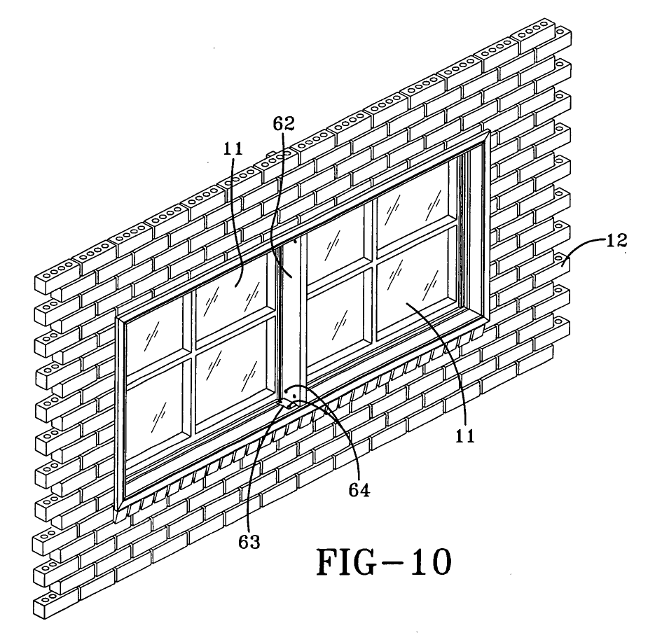

FIG. 10 shows a window 11 which is effectively twice the size of the more conventional window 11 shown in FIG. 1. While covers 13 may come in a variety of sizes to match the sizes of conventional windows, they would not normally be provided of a size to cover a window 11 such as shown in FIG. 10. As an alternative to providing a double wide cover, the present invention may be utilized to mount two covers 13 over the window by adding a center support 62, in the form of a two-by-four or the like, which may be mounted to the window frame by conventional L-brackets 63 and fasteners 64. Then frames 40 can be attached to either side of support 62 as well as around the rest of the periphery of the window halves, to carry a cover 13 in each side of support 62.

In view of the foregoing, it should thus be evident that a the storm cover mounting system constructed as described herein substantially improves the art and otherwise accomplishes the objects of the present invention.

What is claimed is:

1. A system for protecting an opening in a building comprising a fabric cover having spaced openings along edges thereof, a frame around the periphery of the opening, a track in said frame, and a plurality of connector assemblies positioned in said track at the location of said spaced openings in said cover, said connector assemblies attaching said cover to said frame over the opening.

2. The system of claim 1 wherein each said connector assembly includes a head received in said track and a threaded shaft extending from said head and through an opening in said cover.

3. The system of claim 2 wherein each said connector assembly includes an o-ring positioned around said shaft and engaging said frame.

4. The system of claim 2 wherein each said connector assembly includes a nut engaging said cover and received on said shaft.

5. The system of claim 1 wherein there is a slot formed around the periphery of the opening in the building, said frame including a stem received in the slot.

6. The system of claim 5 wherein said stem includes a beveled surface on the end thereof to assist in the insertion of said stem in the slot.

7. The system of claim 5 wherein said stem includes barbs thereon to assist in holding said stem in the slot.

8. The system of claim 5 wherein said stem includes an undercut groove adapted to receive an adhesive to hold said stem in the slot.

9. The system of claim 1 wherein said frame includes a first frame component having said track, a second frame component, and a web connecting said first frame component to said second frame component.

10. The system of claim 9 said frame including a flange carried by said second frame component and adapted to be positioned over the building.

11. The system of claim 9 wherein each said frame has a like plurality of corners, said web being attached between one corner of said first component and one corner of said second component.

12. The system of claim 11 further comprising means to fasten said frame around the opening.

13. The system of claim 12 wherein said web recesses said means to fasten.

14. The system of claim 12 wherein said means to fasten includes a plurality of fasteners received through one wall and one corner of said second frame component.

15. The system of claim 12 wherein said means to fasten includes a plurality of fasteners received through said web.

16. The system of claim 1 further comprising a support to divide the opening into two portions each portion having a said fabric cover and a said frame, each said frame being attached to said support.

17. A frame adapted to be received in a slot formed around the periphery of an opening in a building to be protected by a fabric cover, the frame comprising a track, a plurality of connector assemblies positioned in said track and adapted to carry the cover and a stem extending from said track and adapted to be received in the slot.

18. A frame adapted to be mounted adjacent to an opening in a building to be protected by a fabric cover, the frame comprising a first component, a track carried by said first component, a second component adapted to be attached adjacent to the opening, and a web connecting said first component to said second component.
